(19) United States
(12) Patent Application Publication
(10) Pub. No.: US 2007/0112741 A1
(43) Pub. Date: May 17, 2007

(54) SEARCH ENGINE PROVIDING PERSISTENT SEARCH FUNCTIONALITY OVER MULTIPLE SEARCH QUERIES AND METHOD FOR OPERATING THE SAME

(76) Inventor: C.S. Lee Crawford, Frisco, TX (US)

Correspondence Address: C.S. Lee Crawford, 12132 Terrazzo Lane, Frisco, TX, 75035, US

(21) Appl. No.: 11/559,438

(22) Filed: Nov. 14, 2006

Related U.S. Application Data
(60) Provisional application No. 60/736,252, filed on Nov. 14, 2005.
(60) Provisional application No. 60/759,303, filed on Jan. 17, 2006.
(60) Provisional application No. 60/773,852, filed on Feb. 16, 2006.

(51) Int. Cl. G06F 17/30

(52) U.S. Cl. 707/3

(57) ABSTRACT

In one embodiment, a method of operating a search engine comprises: initiating a continuous search state from a user; receiving multiple search queries during the continuous search state; and providing search results to the user, wherein the providing filters search results previously presented to the user in response to prior search queries during the continuous search state.

### RELATED APPLICATIONS

The present application claims the benefit of the following provisional patent applications: U.S. Provisional Application Ser. No. 60/736,252, filed Nov. 14, 2005, U.S. Provisional Patent Application No. 60/759,303, filed Jan. 17, 2006 and U.S. Provisional Patent Application No. 60/773,852, filed Feb. 16, 2006, all of which are incorporated herein by reference.

### BACKGROUND

A number of search engines exist that provide searching operations to be conducted on documents present on the Internet. However, as the number of documents on the Internet has increased on very substantial basis, the efficiency of search operations using conventional search engines has significantly lessened. Specifically, a keyword search provided by a user to a search engine can present a very large number of “hits” for a user to traverse. Moreover, because of the very large number of documents present on the Internet, the “hits” may include a large number of documents that contain the keywords in a manner not contemplated by and, typically, in an irrelevant manner to the searching user. Accordingly, the user typically must provide multiple queries in an attempt to locate documents of interest.

### SUMMARY

In one embodiment, a method of operating a search engine comprises: initiating a continuous search state from a user; receiving multiple search queries during the continuous search state; and providing search results to the user, wherein the providing filters search results previously presented to the user in response to prior search queries during the continuous search state.

The foregoing has outlined rather broadly certain features and/or technical advantages in order that the detailed description that follows may be better understood. Additional features and/or advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the appended claims.

### BRIEF DESCRIPTION OF THE DRAWINGS

FIG. 1 depicts a web page for initiating a continuous search according to one representative embodiment.

FIG. 2 depicts a response web page for a search engine for a continuous search according to one representative embodiment.

FIG. 3 depicts a web page including search results presented in a manner for user review according to a continuous search according to some representative embodiments.

FIG. 4 depicts a web page after re-sorting operations occur according to one representative embodiment.

FIG. 5 depicts a web page to display stored search results according to one representative embodiment.

FIG. 6 depicts a web page with various prior search terms according to one representative embodiment.

### DETAILED DESCRIPTION

Representative embodiments enable a user to search for documents via a search engine over multiple independent or related queries on an efficient basis. Specifically, some representative embodiments enable a “continuous” search using an Internet search engine to be conducted in which documents can be saved in association across multiple search queries, documents excluded from subsequent query results, documents types of relevance and irrelevance identified for sorting of present and subsequent queries, and/or other such operations spanning multiple search queries. By managing search information across multiple searches, Internet searches can be conducted in an efficient manner.

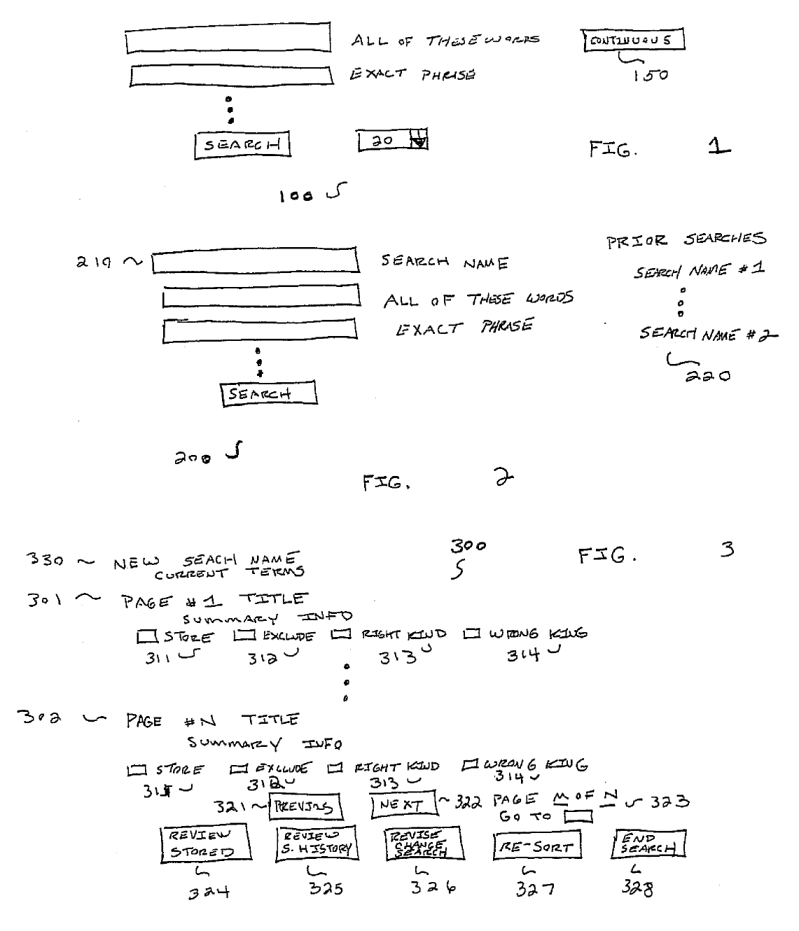

Some representative embodiments enable a user to enter a “continuous” search through the common search engine web page presented by the search engine. FIG. 1 depicts web page 100 for initiating a continuous search according to one representative embodiment. Web page 100 includes the typical graphical controls present in search engines to enter information defining a search query. Web page 100 also includes control 150 (e.g., a “button” or, alternatively, a hyperlink) that allows a user to start a continuous search. By selecting button 150, the selection is communicated to one of the web servers associated with the search engine via typical HTTP processing. The button allows the user to ability to enter the continuous search mode (i.e., the review or resume prior continuous searches or to start a new continuous search).

In response, the search engine generates web page 200 (shown in FIG. 2) according to one representative embodiment. Web page 200 includes the same controls as web page 100 for defining search query terms. The web query term controls shown in FIG. 2 are by way of example. Any suitable set of query term controls could be utilized according to representative embodiments. Web page 200 further includes control 210 for entering a name for the continuous search for further identification to the user (assuming the user wishes to start a new continuous search). Web page 200 further includes list 220 having a list of hyperlinks for prior searches (should the user wish to resume or review a prior search). Depending upon the number of saved searches, additional controls (not shown) could be provided to allow the user to review other searches not immediately displayed in web page 200.

Preferably, the search engine stores a “cookie” on the user system to allow the search engine to identify the user for the presentation of the prior searches of the user. In an alternative embodiment, the user can enter a user id and/or password via an intermediate web page to allow the user to retrieve and control the user's continuous searches. In an alternative embodiment, web pages 100 and 200 could be integrated into a single web page if desired.

Assuming the user starts a new continuous search and enters query terms, the query terms and the search name are communicated to a server of the search engine according to conventional HTTP operations. Search results are generated and sorted according to conventional search engine operations. A first web page of search results is communicated to the user. Also, one or several search file(s) are created to save information for the continuous search. The created search file(s) are associated with the user and the search name.

As shown in FIG. 3, web page 300 illustrates search results presented in a manner for user review according to a continuous search according to some representative embodiments. The typical search results information can be provided such as the titles of the web pages, summary information of the web page (perhaps, including a portion of text from the result document containing the keyword(s)), and other such information. The search results can include hyperlinks (shown as 301 and 302) to allow the user to review the particular result documents. Preferably, the hyperlinks cause the document(s) to be presented in a separate “pop-up” window of the browser. Web page 300 may also include typical controls for navigating the search results (previous page button 321, next page button 322, go to page control 323, etc.)

Each of the search results is preferably associated with one or several controls for continuous search operations. For example, the user can store a reference to a web page using store control 311 (which is preferably a “check-box” or “radio” control). The user can also cause a particular page to be excluded from subsequent search results using control 312. In alternative embodiments, a particular page can be automatically excluded by merely being included in reviewed results associated with a prior search query in the continuous search process. Control 313 enables the user to indicate that the respective document is the type of document that the user wishes to review during the continuous search. Similarly, control 314 enables the user to indicate that the respective document is not the type of document that the user wishes to review during the continuous search.

In a preferred embodiment, controls 311-314 do not operate to transfer information immediately upon selection. Instead, the selections associated with controls 311-314 are communicated when one of the page controls 321, 322, or 323 or continuous search buttons 324-328. Specifically, when one of these buttons or controls are activated by the user, the page information is communicated to a server of the search engine via conventional HTTP operations. The search engine then updates the continuous search file(s).

If the user has selected any search results using a “stored” control 311, an identifier of the particular document (e.g., the URL, the date associated with the time that the web crawler indexed the URL, etc.) is stored in one of the search file(s). In some embodiments, each identified document (e.g., the HTML page, the associated object/image files, etc.) is also stored. The benefit of storing the identified documents is the search can be reviewed at substantially later dates (e.g., after the original documents have been removed from the Internet or otherwise modified).

When the user selects the exclude control 322 for one or several search results, the identifier(s) of the “excluded” document(s) is/are stored. These stored URLs are preferably used to filter these documents from the results generated from subsequent queries. In alternative embodiments, all of the documents identified in a result page are stored in an “exclude” file for filtering results from subsequent search queries within the continuous search.

When the user selects one or several of controls 313 and 314, the URL(s) is/are stored in a search file(s). When subsequent results are sorted, a similarity metric is calculated for each search result against each of the documents identified using controls 313 and 314. The similarity metric can be calculated {how?}. If a search result document is similar to one or several “this type” previously identified documents, the search result document is given a higher weight for the sorting algorithm. If a search result document is similar to one or several “not this type” previously identified documents, the search result document is given a lower weight for the sorting algorithm.

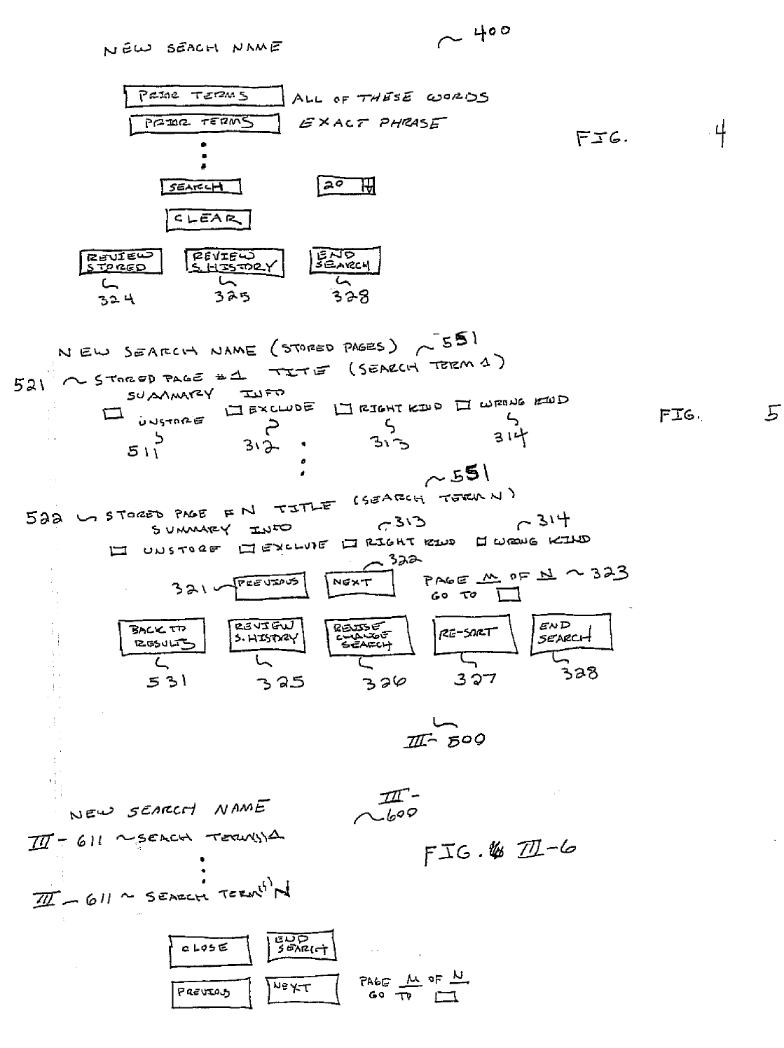

The user can re-sort the current search results using re-sort control 327 as affected by the selection of any of controls 313 and 314. The user can alternatively decide to change the current search terms or enter an entirely new set of search terms using control 326. Upon selection of control 326, the user can be presented web page 400 as shown in FIG. 4. Additionally, the user could review the previously presented search terms by selecting control 325. Web page 600 (as shown in FIG. 6) with various prior search terms 611 could be presented in a pop-up window in response to the selection of control 325. If the user wishes to end or temporarily suspend the continuous search, the user can depress control 328. The user can be taken to a predefined web page (e.g., a “portal page) upon selection of control 328. Also, when the user selects control 328, the state information at the server(s) of the search engine and/or within a cookie on the user system can be modified to reflect the end/suspension of the continuous search.

If the user wishes to review the stored search results, the user may select control 324. Upon selection, web page 500 as shown in FIG. 5 can be generated to display stored search results 521. If the user wishes to review the actual document, the user can click on one of the titles and, preferably, the actual document is displayed in a pop-up window. If user can “unstore” the document using control 511 which causes the identifier of the document to removed from the search file(s). Alternatively, the user could choose to “exclude” the document using control 312. Right kind and wrong kind controls 313 and 314 could also be included within web page 500. Depending upon the number of stored results, controls 321, 322, and 323 could be provided to navigate between multiple pages of stored results. The user could return to the current results generated by the most recent search terms using control 531. Also, in one embodiment, the search term(s) 551 associated with each stored result could be shown adjacent to the respective stored search result.

Some representative embodiments enable a user to conduct an Internet or other search in a substantially efficient manner. A user can quickly review a number of hits, identifying potentially relevant hits, and store the potentially relevant hits for further review. The user can quickly revise the search without losing the stored hits. Also, the user need not repetitively review information that the user has already seen. Specifically, when additional search results are presented in response to revised search terms or new search terms, hits that were deemed irrelevant need not be re-reviewed by the user. The user can also suspend the search at any point and resume the search at a later time if desired. Also, the stored documents can be cached by the search engine to ensure that the user can retrieve the documents at a later time even if the documents become modified or are removed from their original web servers.

When implemented in software, the various elements or components of representative embodiments are the code or software segments adapted to perform the respective tasks. In some embodiments, some of the software is implemented using a freely available web server (such as the APACHE web server) and custom PERL scripts for implementing the continuous search functionality. The program or code segments can be stored in a machine readable medium, such as a processor readable medium, or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable programmable ROM (EPROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

Although representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure that processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method of operating a search engine, comprises:
initiating a continuous search state from a user;
receiving multiple search queries during the continuous search state; and
providing search results to the user, wherein the providing filters search results previously presented to the user in response to prior search queries during the continuous search state.
